(19) United States
(12) Patent Application Publication
(10) Pub. No.: US 2025/0309282 A1
(43) Pub. Date: Oct. 2, 2025

(54) FUEL CELL STACK AND ASSEMBLING METHOD OF FUEL CELL STACK

(71) Applicant: Honda Motor Co., Ltd., Tokyo (JP)

(72) Inventor: Takaaki Shikano, Saitama (JP)

(21) Appl. No.: 19/062,028

(22) Filed: Feb. 25, 2025

(30) Foreign Application Priority Data
Mar. 29, 2024 (JP) 2024-056086

(51) Int. Cl. H01M 8/0254; H01M 8/2404; H01M 8/242

(52) U.S. Cl. CPC H01M 8/0254; H01M 8/2404; H01M 8/242

(57) ABSTRACT

A fuel cell stack including a cell stacked body including power generation cells, a housing surrounding the cell stacked body, and a fixed member fixed to the housing to face an outer surface of the cell stacked body. Each of the power generation cells includes a unitized electrode assembly including a membrane electrode assembly and a frame member having a flexibility and supporting an edge portion of the membrane electrode assembly, and a separator disposed to face the unitized electrode assembly to form a flow path between the separator and the unitized electrode assembly, an edge portion of the frame member includes a protruding portion protruding outward from an edge portion of the separator, and the protruding portion includes a bent end portion bent toward the edge portion of the separator and sandwiched between the fixed portion and the edge portion of the separator.

### CROSS-REFERENCE TO RELATED APPLICATION

This application is based upon and claims the benefit of priority from Japanese Patent Application No. 2024-056086 filed on Mar. 29, 2024, the content of which is incorporated herein by reference.

### BACKGROUND OF THE INVENTION

### Field of the Invention

This invention relates to a fuel cell stack and an assembling method of a fuel cell stack.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack used in this type of fuel cell, there is a known technology in which a projection is provided by resin molding on a peripheral portion of a manifold hole in a resin frame of a membrane electrode assembly so as to cover an inner peripheral surface of a manifold hole of a separator. Such a technology is described, for example, in Japanese Examined Patent Publication No. 5445679 (JP 5445679 B).

However, since the height of the projection provided on the frame in the technology described in JP 5445679 B is small, during cell stacking, the projection may not engage well with the inner peripheral surface of the manifold hole of the separator due to variations in parts, and in such cases, an insulating function cannot be effectively exhibited.

### SUMMARY OF THE INVENTION

An aspect of the present invention is a fuel cell stack including: a cell stacked body including a plurality of power generation cells; a housing surrounding the cell stacked body; and a fixed member fixed to the housing so as to face an outer surface of the cell stacked body. Each of the plurality of power generation cells includes: a unitized electrode assembly including a membrane electrode assembly having an electrolyte membrane and an electrode, and a frame member having a flexibility and formed to support an edge portion of the membrane electrode assembly; and a separator disposed to face the unitized electrode assembly so as to form a flow path in which a reaction gas flows between the separator and the unitized electrode assembly, an edge portion of the frame member includes a protruding portion protruding outward from an edge portion of the separator, and the protruding portion includes a bent end portion bent toward the edge portion of the separator and sandwiched between the fixed portion and the edge portion of the separator.

Another aspect of the present invention is an assembling method of a fuel cell stack including: joining a unitized electrode assembly and a separator disposed to face the unitized electrode assembly to form a cell unit, the unitized electrode assembly including a membrane electrode assembly and a frame member having a flexibility and formed to support an edge of the membrane electrode assembly, the membrane electrode assembly having an electrolyte membrane and an electrode, the separator being configured to form a flow path in which a reaction gas flows between the separator ant the unitized electrode assembly; and stacking a plurality of the cell units while abutting on a fixed member fixed to a housing to form a cell stacked body. The stacking includes stacking the plurality of the cell units while bending an edge portion of the frame member protruding outward from an edge portion of the separator toward the edge portion of the separator and sandwiching the edge portion of the frame member between the fixed member and the edge portion of the separator.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack including a power generation cell stack according to an embodiment of the present invention;

FIG. 2 is a cross-sectional view showing a configuration of a main part in a power generation region of a cell stacked body included in the fuel cell stack in FIG. 1;

FIG. 3 is an exploded perspective view of a unit cell included in the fuel cell stack in FIG. 1;

FIG. 4 is a cross-sectional view taken along line IV-IV of FIG. 1;

FIG. 5 is a plan view illustrating a configuration of a positioning portion provided in a unitized electrode assembly in FIG. 3;

FIG. 6 is a cross-sectional view taken along line VI-VI of FIG. 5;

FIG. 7 is an enlarged view of a part VII of FIG. 4;

FIG. 8 is a cross-sectional view taken along line VIII-VIII of FIG. 7;

FIG. 9 is a flowchart illustrating an assembly procedure of a fuel cell stack according to an embodiment of the present invention;

FIG. 10 is a cross-sectional view of the unit cell for explaining a welding process in FIG. 9;

FIG. 11 is a modification of FIG. 5 and a diagram illustrating the relationship between the unit cell and an impact receiving member; and

FIG. 12 is a diagram illustrating a stacking process of the unit cell corresponding to the impact receiving member in FIG. 11.

### DETAILED DESCRIPTION OF THE INVENTION

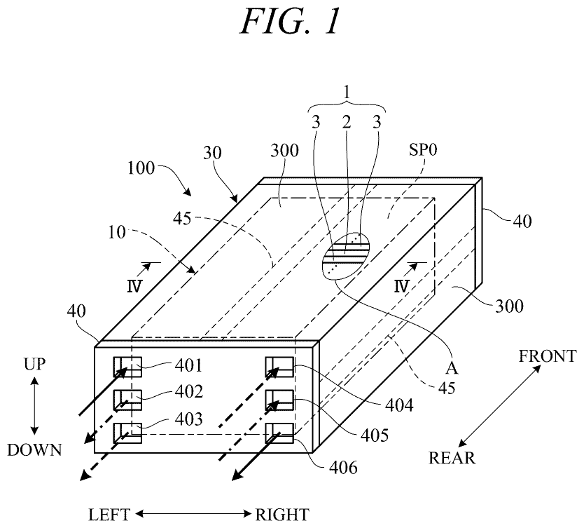

Hereinafter, an embodiment of the present invention will be described with reference to FIGS. 1 to 12. A fuel cell stack according to an embodiment of the present invention is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions may be different from a front-rear direction, a left-right direction, and an up-down direction of the vehicle. The front-rear direction in FIG. 1 is a stacking direction of the fuel cell stack 100, and when assembling the fuel cell stack 100, the stacking direction is aligned with the direction of gravity.

As illustrated in FIG. 1, the fuel cell stack 100 includes a cell stacked body 10, end units 40 disposed on both ends in the front-rear direction of the cell stacked body 10, and a case 30 surrounding the cell stacked body 10, and the whole of the fuel cell stack 100 has a substantially rectangular parallelepiped shape. The length of the fuel cell stack 100 in the left-right direction is longer than the length in the up-down direction. A case or housing that surrounds the cell stacked body 10 is configured by the case 30 and the end units 40.

The case 30 has four substantially rectangular side walls 300, each facing the top, right, bottom, and left surfaces of the cell stacked body 10. These four side walls 300 form a substantially box-shaped housing space SP0 with open the front and rear surfaces. The case 30 is composed of metals such as aluminum or iron.

In part “A” of FIG. 1, a portion of the side wall 300 of the case 30 is shown as broken. As illustrated in part “A” of FIG. 1, the cell stacked body 10 is a stacked body including a plurality of power generation cells 1 (for convenience, only a single cell 1 is illustrated) disposed in the housing space SP0.

The power generation cell 1 has a unitized electrode assembly (hereinafter, referred to as a “UEA”) 2 including a membrane electrode assembly having an electrolyte membrane and an electrode, and separators 3 arranged on both front and rear sides of the UEA 2 to sandwich the UEA 2. The UEA 2 and the separator 3 are alternately arranged in the front-rear direction. The UEA 2 can also be referred to as a membrane electrode structure or a membrane electrode member. In the central part of the power generation cell 1 in the left-right direction, a power generation region is formed where electricity is generated through the electrochemical reaction of hydrogen and oxygen.

A plurality of guide members 45 (only partially shown) are interposed between the cell stacked body 10 and side walls 300 of the case 30. The guide member 45 is a rod-like or plate-like member extending in the front-rear direction, and is attached in advance to the inner surface of the side wall 300. The guide member 45 is previously attached to each of the inner surfaces of the four side walls 300 (the inner wall of the case 30), and the cell stacked body 10 is assembled in this state. During assembly of the fuel cell stack 100, for example, the rear end unit 40 is laid sideways, and a plurality of power generation cells 1 guided by the guide members 45 are stacked thereon to assemble the cell stacked body 10.

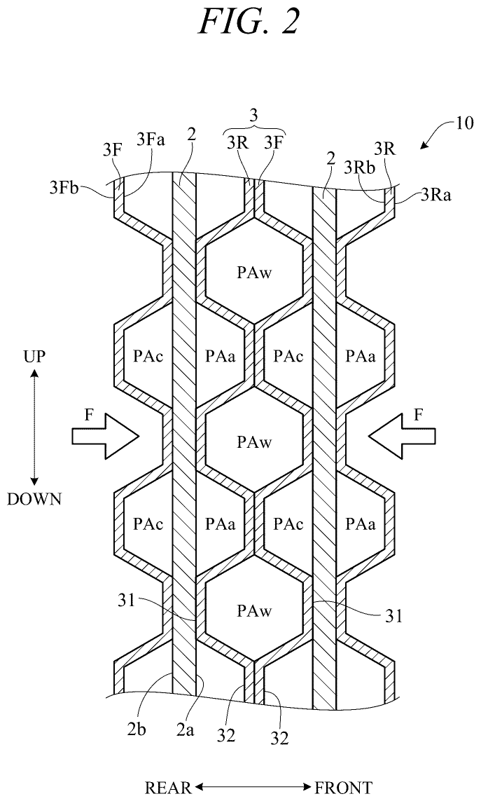

FIG. 2 is a cross-sectional view showing a configuration of a main part in the power generation region of the cell stacked body 10, and more specifically, it is a cross-sectional view cut along a plane extending in the up-down and front-rear directions. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb.

The rear surface 3Fb of the front plate 3F and the front surface 3Ra of the rear plate 3R facing each other are joined together by welding (thermal bonding) or the like at their outer peripheral edges. Thus, the front plate 3F and the rear plate 3R are integrally joined to form a separator 3. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling flows is formed. The generating surface of the power generation cell 1 is cooled by the flow of the cooling medium. Water, for example, can be used as the cooling medium. The surfaces of the separator 3 facing the UEA 2, that is, the front surface 3Fa of the front plate 3F and the rear surface 3Rb of the rear plate 3R, are formed into an uneven shape by press molding or the like to form a gas flow path between the separator 3 and the UEA 2.

More specifically, the separator 3 has a pair of front and rear protruding portions 31 protruding towards the UEA 2, and a pair of front and rear recessed portions 32, which protrudes in a direction away from the UEA 2. The pair of front and rear protruding portions 31 contact the front surface 2a and the rear surface 2b of the UEA 2, respectively.

Between the front surface 2a of the UEA 2 and the rear plate 3R of the separator 3 facing this front surface 2a, an anode flow path PAa through which fuel gas including hydrogen (anode gas) flows is formed by the recessed portion 32. Between the rear surface 2b of the UEA 2 and the front plate 3F of the separator 3 facing this rear surface 2b, a cathode flow path PAc through which oxidant gas including oxygen (cathode gas) flows is formed by the recessed portion 32. The fuel gas and the oxidant gas may be referred to as a reaction gas without being distinguished from each other.

In the cell stacked body 10, a compressive load F is applied in the front-rear direction during the assembly of the fuel cell stack 100. After the assembly of the fuel cell stack 100 is completed, the pair of front and rear end units 40 are fastened to the case 30, thereby maintaining the compressive load F.

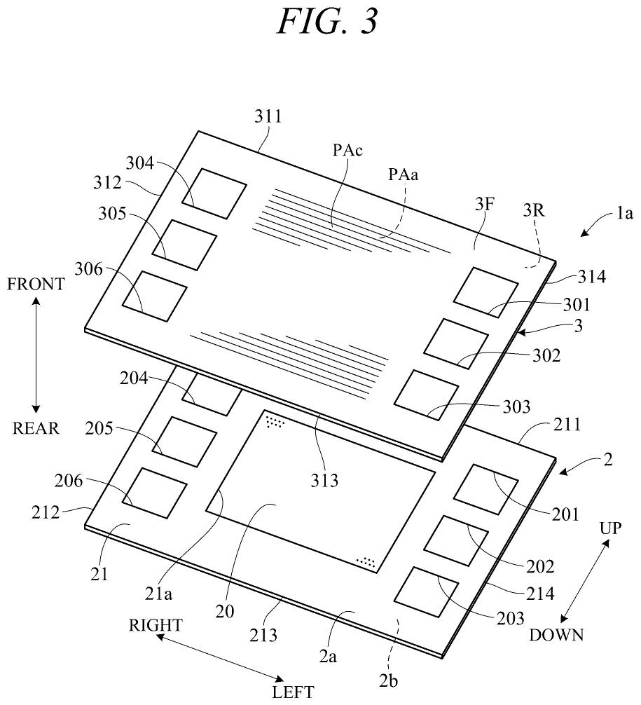

A single UEA2 and a single separator 3 are integrally joined in advance by welding to form a unit cell (a cell unit). FIG. 3 is an exploded perspective view of the unit cell 1a showing the schematic configuration of the UEA 2 and the separator 3. The unit cell 1a is formed by joining the pair of plates 3F and 3R to form the separator 3, and then, for example, overlaying the rear plate 3R of the separator 3 on the front surface 2a of the UEA 2. Although not shown in FIG. 3, a positioning portion for positioning during welding is provided on an outer edge portion of the UEA 2.

As shown in FIG. 3, the UEA 2 includes a substantially rectangular membrane electrode assembly 20 (hereinafter, referred to as a “MEA”) and a frame (film) 21 that supports the MEA 20. The MEA 20 has an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. The cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas.

In the anode electrode, the fuel gas (hydrogen) supplied through the anode flow path PAa (FIG. 2) and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path PAc (FIG. 2) and the gas diffusion layer reacts with hydrogen ions guided from the anode electrode and electrons moved from the anode electrode to generate water. The generated water gives an appropriate humidity to the electrolyte membrane, and excess water is discharged to an outside of the UEA 2.

The frame 21 has a substantially rectangular shape, with its outer edge formed by four sides (upper side 211, left side 212, lower side 213, and right side 214). The frame 21 is made of a resin material with flexibility and insulation properties, such as PPS (polyphenylene sulfide) or PEN (polyethylene naphthalate). A substantially rectangular opening 21a is provided in a central portion of the frame 21. The MEA 20 is disposed to cover the entire opening 21a and a peripheral portion of the MEA 20 is supported by the frame 21. Three through-holes 201 to 203 penetrating the frame 21 in the front-rear direction are opened side by side in the up-down direction on the left side of the opening 21a of the frame 21. Three through-holes 204 to 206 penetrating the frame 21 in the front-rear direction are opened side by side in the up-down direction on the right side of the opening 21a of the frame 21.

The separator 3 has a substantially rectangular shape overall, with its outer edge formed by four sides (upper side 311, left side 312, lower side 313, and right side 314). The separator 3 forms uneven cathode flow paths PAc (FIG. 2) and uneven anode flow paths PAa (FIG. 2) on the front and rear surfaces facing the MEA 20, respectively. In the separator 3, through-holes 301 to 306 penetrating the separator 3 in the front-rear direction are opened at positions corresponding to the through-holes 201 to 206 of the frame 21. The through-holes 301 to 306 communicate with the through-holes 201 to 206 of the frame 21, respectively. The set of these through-holes 201 to 206, 301 to 306, which communicate with each other, forms a plurality of flow paths penetrating the cell stacked body 10 and extending in the front-rear direction.

As shown in FIG. 1, in the rear end unit 40, a plurality of through-holes 401 to 406 penetrating the end unit 40 in the front-rear direction are opened at positions corresponding to the through-holes 201 to 206 and 301 to 306. In the front end unit 40, the through-holes 401 to 406 are not opened. The front end unit 40 is a dry side end unit, and the rear end unit 40 is a wet side end unit.

In the fuel cell stack 100, as indicated by the solid arrow, fuel gas is supplied through the through-hole 401. This fuel gas is guided to the anode flow path PAa through the through-holes 201 and 301. After passing through the anode flow path PAa, the fuel gas is discharged from the through-hole 406 via the through-holes 206 and 306, as indicated by the solid arrow.

In the fuel cell stack 100, as indicated by the dotted arrow, oxidant gas is supplied through the through-hole 404. This oxidant gas is guided to the cathode flow path PAc through the through-holes 204 and 304. After passing through the cathode flow path PAc, the oxidant gas is discharged from the through-hole 403 via the through-holes 203 and 303, as indicated by the dotted arrow.

In the fuel cell stack 100, as indicated by the chain-dotted arrow, cooling medium is supplied through the through-hole 405. This cooling medium is guided to the cooling flow path PAw between the front plate 3F and the rear plate 3R of the separator 3 through the through-holes 205 and 305. After passing through the cooling flow path PAw, the cooling medium is discharged from the through-hole 402 via the through holes 202 and 302, as indicated by the chain-dotted arrow.

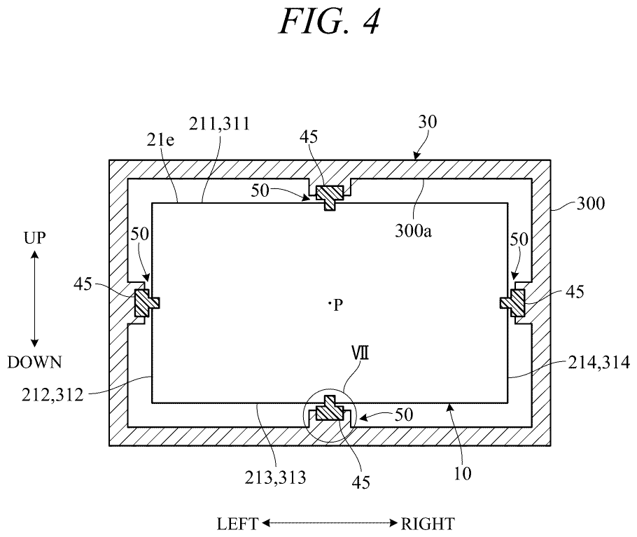

FIG. 4 is a cross-sectional view taken along line IV-IV of FIG. 1. In FIG. 4, only the outer edge portion of the cell stacked body 10 is shown for convenience. FIG. 4 illustrates a center point P which is the center in the left-right direction and the center in the up-down direction of the cell stacked body 10. Hereinafter, a side toward the center point P may be referred to as an inner side, and a side away from the center point P may be referred to as an outer side.

As illustrated in FIG. 4, the guide member 45 is interposed between the cell stacked body 10 and the inner wall surface 300a of the side wall 300 of the case 30. Specifically, the guide member 45 is interposed between the upper sides 211 and 311 of the frame 21 and the separator 3 and the inner wall surface 300a, between the left sides 212 and 312 and the inner wall surface 300a, between the lower sides 213 and 313 and the inner wall surface 300a, and between the right sides 214 and 314 and the inner wall surface 300a, respectively. The positioning portion 50 is provided at the edge portion 21e of the frame 21, and the guide member 45 is fitted to the positioning portion 50.

The positioning portion 50 is provided at a central portion in the left-right direction of the upper side 211 of the frame 21, a central portion in the up-down direction of the left side 212, a central portion in the left-right direction of the lower side 213, and a central portion in the up-down direction of the right side 214. The positioning portion 50 may be provided in a portion other than the central portion in the left-right direction or in a portion other than the central portion in the up-down direction. The configurations of the plurality of guide members 45 and the positioning portion 50 are the same as each other.

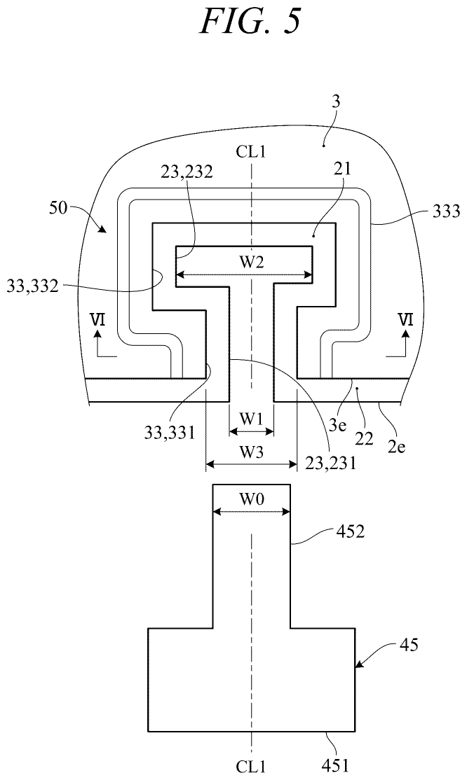

FIG. 5 is a plan view illustrating a configuration of the positioning portion 50. FIG. 5 illustrates the separator 3 stacked on the frame 21, and also illustrates the guide member 45 corresponding to the positioning portion 50. As illustrated in FIG. 5, the guide member 45 has a base portion 451 and a projection 452 protruding inward (toward the center point P in FIG. 4) from the base portion 451, and has a substantially T shape in plan view. The projection 452 has a substantially rectangular shape in plan view and has a width W0 of a predetermined length.

The edge portion 2e of the frame 21 is provided with a protruding portion 22 protruding from the edge portion 3e of the separator 3. The protruding portion 22 is provided with a recessed portion 23 into which the projection 452 of the guide member 45 is fitted. The recessed portion 23 has an inlet recessed portion 231 on the inlet side and an enlarged recessed portion 232 on the back side of the inlet recessed portion 231. The width WI of the inlet recessed portion 231 is smaller than the width W0 of the projection 452. The width W2 of the enlarged recessed portion 232 is larger than the width W0 of the projection 452.

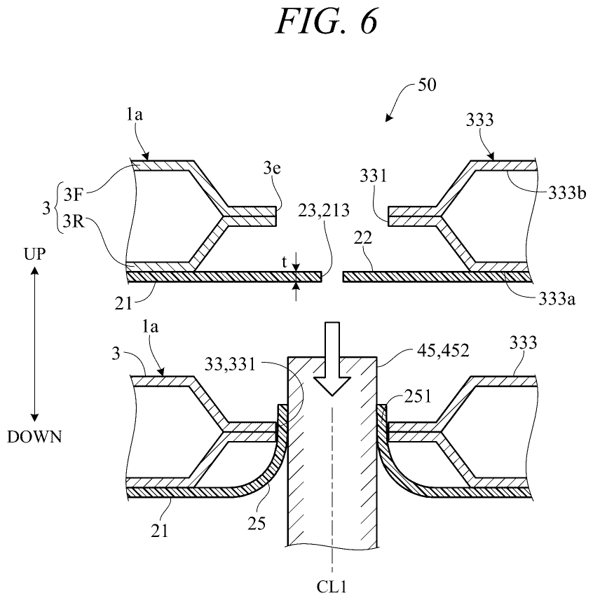

The edge portion 3e of the separator 3 is provided with a recessed portion 33 along the recessed portion 23 so as to surround the recessed portion of the frame 21. Like the recessed portion 23, the recessed portion 33 also has an inlet recessed portion 331 and an enlarged recessed portion 332 wider than the inlet recessed portion 331. The width W3 of the inlet recessed portion 331 is slightly larger than the width W0 of the projection 452. More specifically, the width W3 is equal to or substantially equal to a predetermined width Wα (=W0+2×t) which is a value obtained by adding twice the thickness t (see FIG. 6) of the frame 21 to the width W0 of the projection 452. The width W3 may be larger than the predetermined width Wα.

The recessed portion 23 of the frame 21 constitutes the positioning portion 50. When the axis CLI is defined so as to pass through the center of the projection 452 in the width direction, both the recessed portion 23 and the recessed portion 33 have a symmetrical shape with respect to the axis CL1. The separator 3 is provided with a rib 333 along the edge portion 3e.

FIG. 6 is a cross-sectional view taken along line VI-VI of FIG. 5. FIG. 6 also illustrates a state in the middle of fitting the recessed portion 23 of the frame 21 to the projection 452 of the guide member 45, that is, the stacking process of the unit cells 1a. In FIG. 6, unlike FIG. 1, the up-down direction is defined as the stacking direction, and the stacking direction is matched with the gravity direction. As illustrated in FIG. 6, the rib 333 includes a protruding portion 333a provided on the rear plate 3R and protruding toward the frame 21 of the unit cell 1a, and a recessed portion 333b provided on the front plate 3F and protruding in a direction opposite to the frame 21 of the unit cell 1a. By providing the rib 333, the strength of the separator 3 in the vicinity of the positioning portion 50 can be increased.

In the separator 3, the rear plate 3R and the front plate 3F abut on each other at the edge portion 3e. Therefore, the edge portion 3e of the separator 3 is located away from the frame 21 by a predetermined distance in the up-down direction of FIG. 6, and there is a space where the protruding portion 22 can be bent above the protruding portion 22 of the frame 21.

In the stacking process, as indicated by arrows in FIG. 6, the unit cell 1a is pushed downward from above the guide member 45 while the recessed portion 23 of the frame 21 of the unit cell 1a is fitted to the projection 452 of the guide member 45. As a result, the protruding portion 22 of the frame 21 abuts on the side surface of the guide member 45, and the frame 21 is bent. That is, the bent portion 25 bent upward is formed in the frame 21.

The end portion (bent end portion) 251 of the bent portion 25 is sandwiched between the side surface of the guide member 45 and the recessed portion 33 (inlet recessed portion 331) of the separator 3 without a gap. In this state, the unit cell 1a moves downward while sliding along the side surface of the guide member 45. Thus, the unit cell 1a can be positioned with respect to the guide member 45. In particular, since deformation of the bent portion 25 in the horizontal direction is restricted by the separator 3, the unit cell 1a can be accurately positioned.

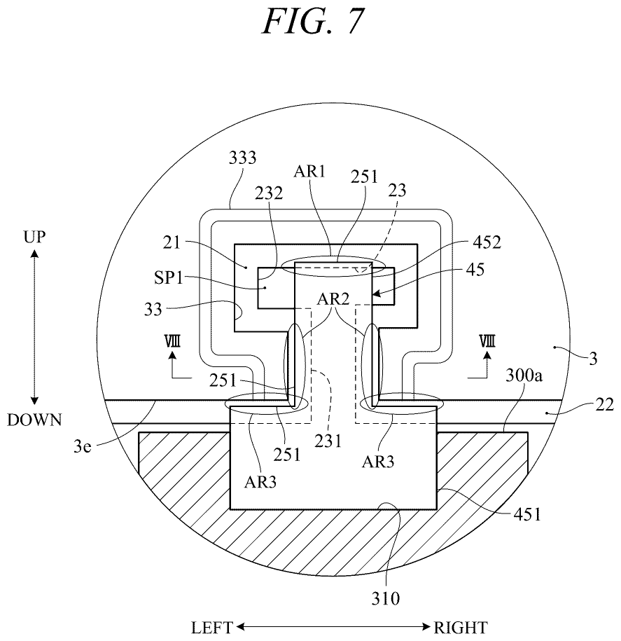

FIG. 7 is an enlarged view of a part VII of FIG. 4 illustrating a state in which the positioning portion 50 is fitted to the guide member 45. In FIG. 7, a state before bending of the frame 21 is indicated by a dotted line. As illustrated in FIG. 7, a recessed portion 310 is provided on the inner wall surface 300a of the side wall 300 of the case 30, and the base portion 451 of the guide member 45 is fitted into the recessed portion 310.

When the guide member 45 is fitted into the recessed portion 23 of the frame 21, as an example, the protruding portion 22 of the frame 21 abuts on the side surface of the guide member 45 in a region AR2 near the inlet recessed portion 231, among a region AR1 near the bottom surface of the recessed portion 23, the region AR2 near the inlet recessed portion 231, and a region AR3 outside the inlet recessed portion 231. As a result, the protruding portion 22 is bent in the region AR2, and the bent end portion 251 (FIG. 6) of the frame 21 is provided between the guide member 45 and the edge portion 3e of the separator 3. Although different from that illustrated in FIG. 7, in the present embodiment, in the regions AR1 and AR3, the protruding portion 22 of the frame 21 does not come into contact with the guide member 45, and a gap is generated between the protruding portion 22 and the guide member 45.

As illustrated in FIG. 7, the protruding portion 22 of the frame 21 may abut on the guide member 45 in all the regions AR1 to AR3. Accordingly, the protruding portion 22 is bent in the regions AR1 to AR3, and the bent end portion 251 of the frame 21 is provided between the guide member 45 and the edge portion 3e of the separator 3. However, considering that the positioning portions 50 are provided on the four sides of the separator 3, it is sufficient to bend only the region AR2.

Since the enlarged recessed portion 232 wider than the projection 452 of the guide member 45 is provided in the protruding portion 22 of the frame 21, a space SP1 exists between the projection 452 and the enlarged recessed portion 232. As a result, since the protruding portion 22 can be deformed in the space SP1, for example, in a case where the protruding portion 22 is configured to be bent in all the regions AR1 to AR3, the protruding portion 22 can be smoothly bent.

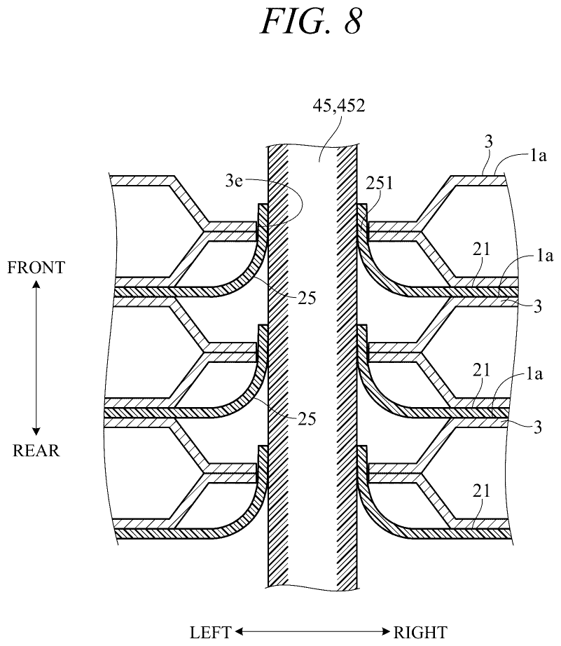

FIG. 8 is a cross-sectional view taken along line VIII-VIII of FIG. 7. As illustrated in FIG. 8, in an assembled state of the fuel cell stack 100 in which the plurality of unit cells 1a are stacked, the frame 21 is bent so as to cover the whole of the separator 3, and the bent end portion 251 at a distal end of the bent portion 25 is sandwiched between the edge portion 3e of the separator 3 and the guide member 45. As a result, the unit cell 1a is positioned by the guide member 45, and the relative movement of the unit cell 1a with respect to the case 30 can be prevented. Further, since the separators 3 are covered with the frame 21 which is an insulator, the separators can be well insulated from each other.

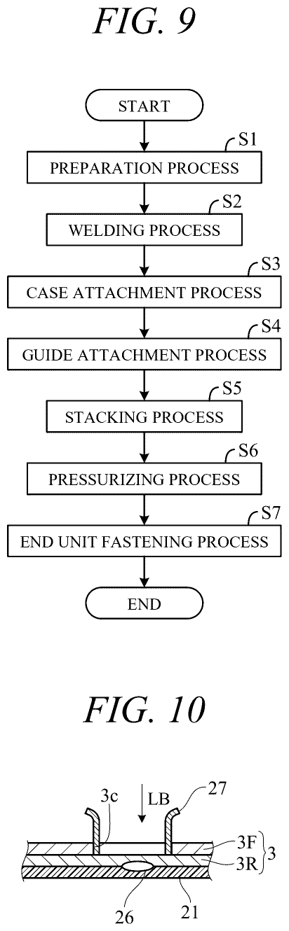

A method for manufacturing the fuel cell stack 100 will be described. FIG. 9 is a flowchart illustrating an example of an assembly procedure of the fuel cell stack 100. In a case where the fuel cell stack 100 is manufactured, as illustrated in FIG. 9, first, in S1 (S: processing step), the UEA 2 and the separator 3 as illustrated in FIG. 3 are prepared (preparation process).

Next, in S2, the UEA 2 and the separator are joined to manufacture the unit cell 1a. Specifically, the UEA 2 and the separator 3 are sequentially positioned and mounted on a processing table (not illustrated), and then the UEA 2 and the separator 3 are joined by welding at a predetermined welding portion (welding process).

FIG. 10 is a cross-sectional view of the unit cell 1a for explaining the welding process. As illustrated in FIG. 10, a substantially circular through-hole 3c is opened in advance in the front plate 3F of the separator 3 facing the welding portion (thermal bonding portion) 26. The substantially cylindrical jig 27 is inserted from above through the through-hole 3c, and the jig 27 presses the rear plate 3R so that the rear plate 3R and the frame 21 are in close contact with each other. The jig 27 can be omitted.

The welding portion 26 is irradiated with a laser beam LB using a laser processing machine attached to a hand of a robot (not illustrated). That is, the laser beam LB is emitted from above the separator 3 toward the rear plate 3R through the through-hole 3c as indicated by an arrow. As a result, the welding portion 26 is heated to melt a part of the frame 21, and the rear plate 3R of the separator 3 and the frame 21 can be welded.

Although not illustrated, the welding portion 26 is provided in the vicinity of the positioning portion 50. The welding portion 26 may be provided in the vicinity of the corner of the frame 21. The welding portion 26 may be provided at a position where the front plate 3F of the separator 3 is separated from the rear plate 3R (for example, below the rib 333 in FIG. 6).

Next, in S3, the case 30 is fixed to the end unit 40 on the wet side (rear side in FIG. 1) using bolts (case attachment process). The upper surface of the wet-side end unit 40 is provided with a recessed portion into which the lower end portion (the rear end portion in FIG. 1) of the guide member 45 is fitted, in advance corresponding to the attachment position (FIG. 4) of the guide member 45.

Next, in S4, the lower end portion of the resin guide member 45 is fitted into the recessed portion of the wet-side end unit 40, and the guide member 45 is fitted into the recessed portion 310 of the inner wall surface 300a of the case 30. Accordingly, the guide member 45 is attached to the case 30 (guide attachment process).

Next, in S5, the plurality of unit cells 1a are accommodated in the case 30 along the guide member 45 from above, and a predetermined number of unit cells 1a are stacked (stacking process). Specifically, as illustrated in FIG. 6, the protruding portion 22 of the frame 21 is bent, and the end portion 251 of the bent portion 25 is sandwiched between the edge portion 3e of the separator 3 and the guide member 45. Then, the frame 21 is lowered while being slid along the guide member 45 to stack the plurality of unit cells 1a. As a result, the unit cell 1a is positioned with respect to the case 30, and the insulating function of the separator 3 can be secured by the frame 21. When the cell stacked body 10 is formed by stacking a predetermined number of unit cells 1a, the dry-side end unit 40 is mounted on the cell stacked body 10.

Next, in S6, a pressurizing force is applied from above the dry-side end unit 40 using a pressurizing machine (not illustrated), and the dry-side end unit 40 is pushed downward until it abuts against the upper end surface of the case 30 (pressurizing process). As a result, a predetermined compressive load F (FIG. 2) is applied to the cell stacked body 10.

Next, in S7, the dry-side end unit 40 is fastened to the upper end surface of the case 30 using a bolt (end unit fastening process). As a result, the cell stacked body 10 is held in the case in a state where the predetermined compressive load F is applied. Thus, manufacturing of the fuel cell stack 100 is completed.

According to the present embodiment, the following operations and effects can be achieved.
(1) The fuel cell stack 100 includes the cell stacked body 10 having a plurality of power generation cells 1; the case 30 and the end unit 40 surrounding the cell stacked body 10; and the guide member 45 fixed to the case 30 so as to face an outer surface of the cell stacked body 10 (FIG. 1). The power generation cell 1 includes: the UEA 2 which includes the MEA 20 including an electrolyte membrane and an electrode and the flexible frame 21 supporting an edge portion of the MEA 20; and the separator 3 which is disposed opposite to the UEA 2 so as to form a flow path (anode flow path PAa, cathode flow path PAc) through which the reaction gas flows between the separator 3 and the UEA 2 (FIGS. 2 and 3). The edge portion 2e of the frame 21 has the protruding portion 22 protruding outward from the edge portion 3e of the separator 3 (FIG. 5). The protruding portion 22 has the bent end portion 251 which is bent toward the edge portion 3e of the separator 3 and sandwiched between the guide member 45 and the edge portion 3e of the separator 3 (FIG. 6).

With this configuration, the insulating frame 21 can be sandwiched between the guide member 45 and the edge portion 3e of the separator 3 regardless of variations in components such as the UEA 2, the separator 3, the case 30, and the guide member 45. Thus, the separator 3 can be well insulated. In addition, the thickness t (FIG. 6) of the frame 21 is constant, and the frame 21 can be configured at low cost as compared with the case where the frame 21 is provided with the protruding portion. Furthermore, since the separator 3 does not come into contact with the guide member 45, the surface of the guide member 45 can be prevented from being scraped by the separator 3.
(2) The cell stacked body 10 is configured by stacking a plurality of unit cells 1a, and the unit cells 1a include a single UEA 2 and a single separator 3 welded (joined) to each other via a welding portion 26 (joining portion) (FIG. 3). As a result, it is not necessary to provide a positioning function in the separator 3, and the separator 3 can be easily configured.
(3) The separator 3 has the protruding portion 333a (a first protruding portion) protruding toward the frame 21 and the recessed portion 333b (a second protruding portion) protruding in a direction away from the frame 21 (FIG. 6). The protruding portion 22 is bent toward the edge portion 3e of the separator 3 separated from the frame 21, and the bent end portion 251 is sandwiched between the guide member 45 and the edge portion 3e (FIG. 6). As a result, since the bent end portion 251 is sandwiched between the edge portion 3e of the pair of front and rear plates 3F and 3R of the separator 3 and the guide member 45, the contact area between the frame 21 and the edge portion 3e of the separator 3 is large, and the bent end portion 251 can be stably sandwiched.
(4) The guide member 45 positions the power generation cell 1 (unit cell 1a) with respect to the case 30 (FIG. 4). The edge portion 3e of the separator 3 has the recessed portion 33 that is fitted to the guide member 45 via the bent end portion 251 (FIG. 7). As a result, the deformation of the frame 21 in the direction orthogonal to the stacking direction of the unit cells 1a is restricted by the recessed portion 33 of the separator 3, and the unit cells 1a can be favorably positioned.
(5) An assembling method of a fuel cell stack includes: a joining process of joining a UEA 2 having a MEA 20 including an electrolyte membrane and an electrode and a flexible frame 21 supporting an edge portion of the MEA 20, and a separator 3 disposed opposite to the UEA 2 so as to form a flow path (anode flow path PAa, cathode flow path PAc) through which a reaction gas flows between the separator 3 and the UEA 2 to form a unit cell 1a; and a stacking process of stacking a plurality of unit cells 1a while abutting on a guide member 45 fixed to a case 30 to form a cell stacked body 10 (FIG. 9). The stacking process includes stacking the unit cells 1a while bending the frame 21 protruding outward from the edge portion 3e of the separator 3 toward the edge portion 3e of the separator 3 and sandwiching the frame between the guide member 45 and the edge portion 3e of the separator 3 (FIG. 6). As a result, the insulating function can be favorably exhibited regardless of variations in components such as the UEA 2, the separator 3, the case 30, and the guide member 45.

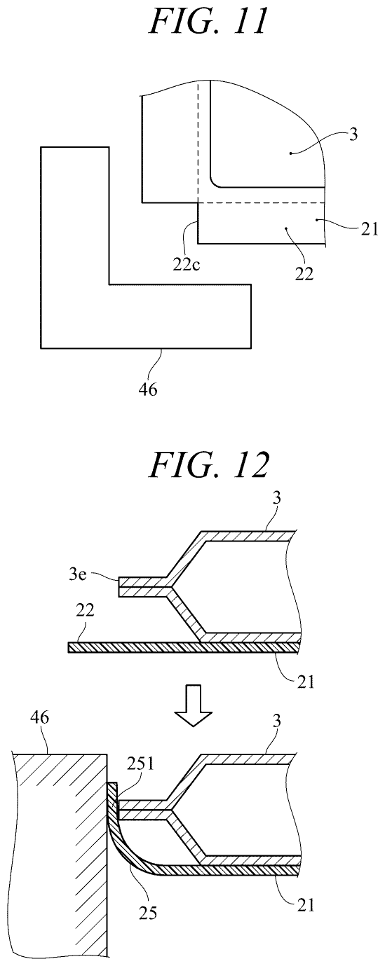

The configuration of the positioning portion 50 fitted to the guide member 45 has been described above. That is, although the bent portion 25 is provided in the recessed portion 23 of the frame 21 constituting the positioning portion 50, the portion where the bent portion 25 is provided, is not limited to the positioning portion 50. In other words, the member on which the bent portion 25 abuts, is not limited to the guide member 45. FIG. 11 is a diagram illustrating an example of the configuration. Similarly to FIG. 5, FIG. 11 illustrates a part of the unit cell 1a and the impact receiving member 46 corresponding to the unit cell 1a in a state of being separated from each other for convenience.

As illustrated in FIG. 11, the impact receiving member 46 has a substantially L shape in plan view as viewed from the stacking direction of the fuel cell stack 100. The impact receiving member 46 is made of a resin material, and is attached to a corner of the inner wall surface 300a of the side wall 300 of the case 30 with an adhesive or the like. The impact receiving member 46 extends in the stacking direction, and restricts the movement of the cell stacked body 10 due to an inertial force when an external impact acts on the fuel cell stack 100.

The frame 21 has a protruding portion 22 protruding outward from the edge portion 3e of the separator. The protruding portion 22 has a substantially rectangular notch 22c at a corner. At the time of stacking the unit cells 1a, as illustrated in FIG. 12, the protruding portion 22 abuts on the impact receiving member 46 and is bent, for example, along a dotted line (FIG. 11) on the extension of the notch 22c. As a result, the bent portion 25 is formed in the frame 21, and the bent end portion 251 is sandwiched between the edge portion 3e of the separator 3 and the impact receiving member 46.

The above embodiment can be modified in various forms. Below, some modified examples are described. In the above embodiment, the guide member 45 is fixed to the inner wall surface 300a of the case 30 as a housing, but both ends of the guide member may be fixed to the pair of end units 40 as a housing. In the above embodiment, the protruding portion 22 of the frame 21 as a frame member is made to contact the guide member 45 or the impact receiving member 46, but the protruding portion of the frame member may contact another fixed member fixed to the housing facing the outer surface of the cell stacked body 10.

In the above embodiment, the recessed portion 23 provided on the edge portion 21e of the frame 21 is fitted with the guide member 45, but it may be engaged instead of fitted. In the above embodiment, the recessed portion 33 provided on the edge portion 3e of the separator 3 is fitted with the guide member 45 via the bent end portion 251 of the frame 21, but it may be engaged instead of fitted. In the above embodiment, the recessed portion 23 as a positioning portion is provided near the rib 333 of the separator 3, but the position where the positioning portion is provided is not limited to the above. In the above embodiment, the UEA 2 and the separator 3 are joined by welding to form a unit cell 1a (cell unit), but they may be joined with an adhesive or the like, and the joining process is not limited to the above.

The above embodiment can be combined as desired with one or more of the above modifications. The modifications can also be combined with one another.

According to the present invention, it is possible to effectively achieve insulation function regardless of variations in components.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells;
a housing surrounding the cell stacked body; and
a fixed member fixed to the housing so as to face an outer surface of the cell stacked body, wherein
each of the plurality of power generation cells includes:
a unitized electrode assembly including a membrane electrode assembly having an electrolyte membrane and an electrode, and a frame member having a flexibility and formed to support an edge portion of the membrane electrode assembly; and
a separator disposed to face the unitized electrode assembly so as to form a flow path in which a reaction gas flows between the separator and the unitized electrode assembly,
an edge portion of the frame member includes a protruding portion protruding outward from an edge portion of the separator, and
the protruding portion includes a bent end portion bent toward the edge portion of the separator and sandwiched between the fixed portion and the edge portion of the separator.

2. The fuel cell stack according to claim 1, wherein
the cell stacked body is configured by stacking a plurality of cell units, and
each of the plurality of cell units includes the unitized electrode assembly and the separator joined to each other at a joining portion.

3. The fuel cell stack according to claim 1, wherein
the separator includes a first protruding portion protruding toward the frame member and a second protruding portion protruding in a direction away from the frame member,
the protruding portion is bent toward the edge portion of the separator, the edge portion of the separator being located away from the frame member, and
the bent end portion is sandwiched between the fixed member and the edge portion of the separator.

4. The fuel cell stack according to claim 3, wherein
the separator includes a pair of plate members joined to each other,
the first protruding portion is formed in one of the pair of plate members, and
the second protruding portion is formed in another of the pair of plate members.

5. The fuel cell stack according to claim 1, wherein
the fixed member is a guide member configured to position the plurality of power generation cells with respect to the housing, and
the edge portion of the separator is configured to engage with or fit to the guide member through the bent end portion.

6. The fuel cell stack according to claim 5, wherein
each of the frame member and the separator includes a recessed portion in which the guide member is fitted.

7. The fuel cell stack according to claim 6, wherein
the separator includes a rib provided around the recessed portion.

8. An assembling method of a fuel cell stack, comprising
joining a unitized electrode assembly and a separator disposed to face the unitized electrode assembly to form a cell unit, the unitized electrode assembly including a membrane electrode assembly and a frame member having a flexibility and formed to support an edge of the membrane electrode assembly, the membrane electrode assembly having an electrolyte membrane and an electrode, the separator being configured to form a flow path in which a reaction gas flows between the separator and the unitized electrode assembly; and
stacking a plurality of the cell units while abutting on a fixed member fixed to a housing to form a cell stacked body, wherein
the stacking includes stacking the plurality of the cell units while bending an edge portion of the frame member protruding outward from an edge portion of the separator toward the edge portion of the separator and sandwiching the edge portion of the frame member between the fixed member and the edge portion of the separator.
